(19) United States
(12) Patent Application Publication
(10) Pub. No.: US 2021/0376500 A1
(43) Pub. Date: Dec. 2, 2021

(54) TERMINAL-ATTACHED ELECTRIC WIRE AND METHOD OF MANUFACTURING TERMINAL-ATTACHED ELECTRIC WIRE

(71) Applicants: AUTONETWORKS TECHNOLOGIES, LTD, Yokkaichi-shi, Mie-ken, (JP); SUMITOMO WIRING SYSTEMS, LTD, Yokkaichi-shi, Mie-ken, (JP); SUMITOMO ELECTRIC INDUSTRIES, LTD, Osaka-shi, Osaka (JP)

(72) Inventors: Mitsuru HIROSE, Yokkaichi-shi (JP); Koji FUKUMOTO, Yokkaichi-shi (JP); Daisuke HASHIMOTO, Yokkaichi-shi (JP); Tetsuya NAKAMURA, Yokkaichi-shi (JP); Kazuo NAKASHIMA, Yokkaichi-shi (JP); Shigeyuki TANAKA, Osaka-shi (JP); Taro FUJITA, Osaka-shi (JP); Shinya NISHIKAWA, Osaka-shi (JP)

(73) Assignees: AUTONETWORKS TECHNOLOGIES, LTD., Yokkaichi-shi, Mie-ken (JP); SUMITOMO WIRING SYSTEMS, LTD., Yokkaichi-shi, Mie-ken (JP); SUMITOMO ELECTRIC INDUSTRIES, LTD., Osaka-shi, Osaka (JP)

(21) Appl. No.: 16/760,260

(22) PCT Filed: Nov. 9, 2018
(86) PCT No.: PCT/JP2018/041747

§ 371 Date: Apr. 29, 2020

(30) Foreign Application Priority Data
Nov. 15, 2017 (JP) 2017-220167

(51) Int. Cl. H01R 4/72; H01R 11/11; H01R 43/00

(52) U.S. Cl. CPC H01R 4/72; H01R 43/005; H01R 11/11

(57) ABSTRACT

A terminal-attached electric wire includes: an insulated electric wire which includes a core wire and an insulating material covering the periphery of the core wire; a terminal fitting electrically connected to the core wire at the end of the insulated electric wire; and an adhesive tube covering the end of the insulating material. The terminal-attached electric wire includes a molding portion formed to cover a region extending from a core wire-connected portion of the terminal fitting which is connected to the core wire to a middle portion in an axial direction of the adhesive tube. The outer peripheral surface of the adhesive tube is adhered to the inner peripheral surface of the molding portion. The inner peripheral surface of the adhesive tube is adhered to the outer peripheral surface of the insulating material.

### TECHNICAL FIELD

The present invention relates to a terminal-attached electric wire and a method for manufacturing the terminal-attached electric wire.

### BACKGROUND ART

In recent electric vehicles, hybrid vehicles, or the like, various types of electric devices are electrically connected by a wire harness or the like. In the wire harness, a terminal-attached electric wire includes an insulated electric wire and a terminal metal fitting connected to an end of the insulated electric wire. The insulated electric wire includes an insulator that covers the periphery of the core wire. Further, the terminal-attached electric wire includes a mold portion that covers a portion connecting the core wire of the insulated electric wire and the terminal metal fitting.

Further, to prevent the edge of the mold portion from damaging the insulator, a terminal-attached electric wire has been developed employing a structure in which an end portion of the insulator is covered by a heat shrinkable tube and the mold portion is molded so that the edge of the mold portion is located at the covered portion (for example, refer to Patent Document 1).

### PRIOR ART DOCUMENT

### Patent Document

Patent Document 1: Japanese Laid-Open Patent Publication No. 2015-135761

### SUMMARY OF THE INVENTION

### Problems that the Invention is to Solve

In the above terminal-attached electric wire, liquid may enter the gap between the heat shrinkable tube and the mold portion. If the liquid reaches the portion connecting the core wire of the insulated electric wire and the terminal metal fitting, electric problems such as short circuiting may occur at the connecting portion. Thus, with the terminal-attached electric wire, there is a need to improve waterproofness of the molding portion, which covers the portion connecting the core wire of the insulated electric wire and the terminal metal fitting.

Accordingly, it is an objective of the present invention to provide a terminal-attached electric wire that improves the waterproofness of the mold portion while limiting damages to the insulator.

### Means for Solving the Problems

A terminal-attached electric wire that solves the above problems includes an insulated electric wire, a terminal metal fitting, an adhesive tube, and a mold portion. The insulated electric wire includes a core wire and an insulator that covers a periphery of the core wire. The terminal metal fitting is electrically connected to the core wire at an end of the insulated electric wire. The adhesive tube covers an end portion of the insulator. The mold portion is formed to cover a region from a portion of the terminal metal fitting connected to the core wire to an axially intermediate portion of the adhesive tube. The adhesive tube is formed to be a tubular member before being arranged on the end portion of the insulator. The adhesive tube includes an outer circumferential surface that is adhered to an inner circumferential surface of the mold portion. The adhesive tube includes an inner circumferential surface that is adhered to an outer circumferential surface of the insulator.

### Effects of the Invention

The terminal-attached electric wire of the present invention improves the waterproofness of the mold portion while limiting damages to the insulator.

### BRIEF DESCRIPTION OF THE DRAWINGS

FIG. 1 is a cross-sectional view showing a terminal-attached electric wire of one embodiment.

FIG. 2 is a cross-sectional view illustrating a manufacturing process of the terminal-attached electric wire in accordance with the embodiment.

FIG. 3 is a cross-sectional view illustrating the manufacturing process of the terminal-attached electric wire in accordance with the embodiment.

FIG. 4 is a cross-sectional view illustrating the manufacturing process of the terminal-attached electric wire in accordance with the embodiment.

### MODES FOR CARRYING OUT THE INVENTION

One embodiment of a terminal-attached electric wire will now be described with reference to the drawings.

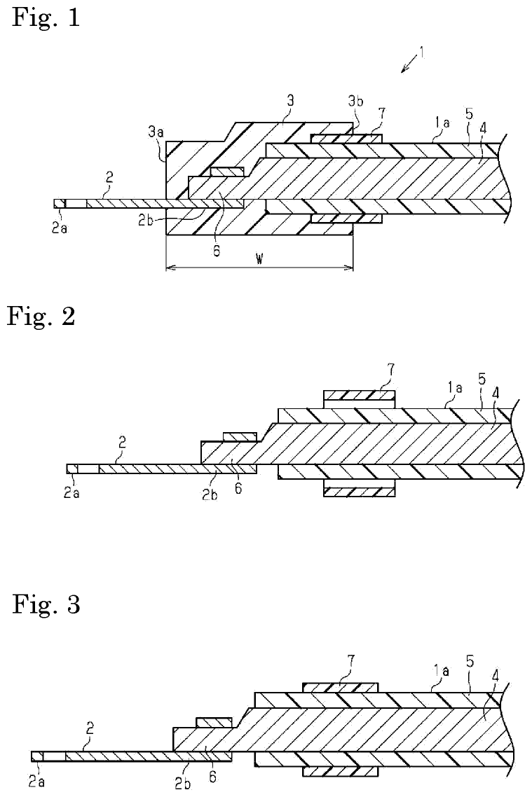

As shown in FIG. 1, a terminal-attached electric wire 1 is an electric wire that forms a wire harness, which electrically connects various types of electric devices installed in an automobile. The terminal-attached electric wire 1 is used as, for example, an electric wire that supplies high-voltage power to an electric device.

The terminal-attached electric wire 1 includes an insulated electric wire 1a, a terminal metal fitting 2, a mold portion 3, and an adhesive tube 7.

The insulated electric wire 1a includes a core wire 4 and an insulator 5. The core wire 4 is an elongated conductor. The insulated electric wire covers the periphery of the core wire 4. The core wire 4 is formed of a metal material such as copper, copper alloy, aluminum, or aluminum alloy. For example, a single-core wire or a stranded wire having multiple twisted strands may be used as the core wire 4. The material of the insulator 5 may be a synthetic resin having a main component of, for example, a polyolefin-based resin such as cross-linked polyethylene or cross-linked polypropylene. The material of the insulator 5 may be of only one type of a material or a combination of two or more types of materials.

The insulated electric wire 1a includes an end defining an exposed portion 6 where the core wire 4 is exposed from the insulator 5. For example, at the end of the insulated electric wire 1a in the exposed portion 6, the insulator 5 is removed from a distal end of the insulated electric wire 1a over a certain length to expose the end of the core wire 4 from the insulator 5.

The terminal metal fitting 2 includes a contact point portion 2a and a core wire connecting portion 2b. The terminal metal fitting 2 is formed of, for example, copper or copper alloy. The contact point portion 2a is electrically connected to a connection counterpart such as a bus bar, a terminal portion of an electric device, or a terminal of another terminal-attached electric wire. The contact point portion 2a is exposed to the outside from the mold portion 3 and projects outward of the mold portion 3. The contact point portion 2a of the present example has the form of a flat plate and includes a through hole through which a screw is inserted. The contact point portion 2a may have a different form such as that of a plate or a rod and may not include a through hole.

The core wire connecting portion 2b is fixed to the core wire 4 at the exposed portion 6. The core wire connecting portion 2b is electrically connected to the core wire 4 at the exposed portion 6. The core wire connecting portion 2b is fixed to the core wire 4 at the exposed portion 6 by, for example, crimping or ultrasonic welding.

The adhesive tube 7 covers an end portion of the insulator 5. The adhesive tube 7 surrounds the entire outer circumferential surface of the insulator 5 at the end portion in the circumferential direction. The adhesive tube 7 has an inner circumferential surface that is adhered to the entire outer circumferential surface of the insulator 5 in the circumferential direction without any gaps. Further, the adhesive tube 7 includes an outer circumferential surface that is attached to the entire inner circumferential surface of the mold portion 3 in the circumferential direction without any gaps. For example, the inner circumferential surface of the adhesive tube 7 is adhered to the outer circumferential surface of the insulator 5 by welding, and the outer circumferential surface of the adhesive tube 7 is adhered to the inner circumferential surface of the mold portion 3 by welding. Here, the welding (heat-welding) may be, for example, ultrasonic welding, vibration welding, high-frequency welding, laser welding, infrared welding, friction welding, hot-plate welding, or hot-air welding.

The adhesive tube 7 is molded in advance to be a tubular member and coupled to the end portion of the insulator 5 so as to be in touch contact with the entire outer circumferential surface of the insulator 5. The adhesive tube 7 is not formed by applying or dropping an adhesive on the outer circumferential surface of the insulator 5. Rather, the adhesive tube 7 has the form of a tubular body (hollow cylinder) from its creation before the insulator 5 (insulated electric wire 1a) is arranged therein. Further, the inner diameter of the adhesive tube 7 is greater than the outer diameter of the insulator 5 before the insulator 5 is arranged therein. For example, a shrinkable tube may be used as the adhesive tube 7. The shrinkable tube may be, for example, a heat shrinkable tube. To obtain the heat shrinkable tube, for example, a resin member, which is an extremely fine tube molded by performing extrusion-molding, is stretched in a heated state into a thick tube and then cooled. The obtained heat shrinkable tube has shape-memory properties and, when heated, shrinks back to the fine tube defined in the state prior to being stretched.

The adhesive tube 7 of the present example is a single-layered member. Specifically, the adhesive tube 7 of the present example differs from a member having a laminated structure in which, for example, adhesive layers are formed on the inner circumferential surface and the outer circumferential surface of the heat shrinkable tube.

The material of the adhesive tube 7 may be, for example, a thermoplastic synthetic resin. It is preferred that, for example, a thermoplastic resin having a cross-linked structure be used as the thermoplastic synthetic resin. For example, a thermoplastic resin having a cross-linked structure that is cross-linked by irradiation using an electron beam may be used as the thermoplastic resin. The material of the adhesive tube 7 may be, for example, a synthetic resin of the same type as the insulator 5 (e.g., synthetic resin having a main component of a polyolefin-based resin such as cross-linked polyethylene or cross-linked polypropylene). The material of the adhesive tube 7 may be of only a single type of a material or a combination of two or more types of materials.

Preferably, the adhesive tube 7 has a wall thickness, for example, in a range of 50 to 2000 μm, further preferably in a range of 100 to 1500 μm, and even further preferably in a range of 100 to 1000 μm. The adhesive tube 7 has the form of a cylinder from its creation before the insulator 5 is arranged therein. Thus, the adhesive tube 7 is thicker than when formed by applying an adhesive or the like.

The mold portion 3 is formed to cover a protection region that includes a region from a portion of the terminal metal fitting 2 connected to the core wire 4 (i.e., core wire connecting portion 2b) to the outer circumferential surface of the adhesive tube 7. Further, the contact point portion 2a of the terminal metal fitting 2 is exposed to the outside from the mold portion 3. The mold portion 3 of the present example covers a protection region extending from an intermediate portion of the terminal metal fitting 2 (specifically, a portion between contact point portion 2a and core wire connecting portion 2b) to an axially (longitudinally) intermediate portion of the adhesive tube 7. Specifically, the mold portion 3 of the present example embeds part of the adhesive tube 7, the end of the insulated electric wire 1a including the exposed portion 6, the portion connecting the terminal metal fitting 2 and the core wire 4, and the core wire connecting portion 2b of the terminal metal fitting 2. Further, the contact point portion 2a of the terminal metal fitting 2 projects out of a distal end 3a of the mold portion 3, and part of the adhesive tube 7 is exposed to the outside from a rear end 3b of the mold portion 3. That is, the rear end 3b of the mold portion 3 is located on the axially intermediate portion of the adhesive tube 7, and the adhesive tube 7 is arranged between the rear end 3b of the mold portion 3 and the insulator 5.

The mold portion 3 is formed by, for example, insert molding in which the above-described protection region of the terminal-attached electric wire 1 is used as the insert. The mold portion 3 is formed integrally with the insulated electric wire 1a and the terminal metal fitting 2.

The outer circumferential surface of the adhesive tube 7 is adhered to the inner circumferential surface in the rear end 3b of the mold portion 3. Further, for example, at the inner circumferential surface of the distal end 3a, the mold portion 3 is in touch contact with the entire outer circumferential surface of the portion between the contact point portion 2a and the core wire connecting portion 2b of the terminal metal fitting 2. This obviates the entrance of liquid into the portion connecting the core wire 4 of the insulated electric wire 1a and the core wire connecting portion 2b of the terminal metal fitting 2.

The material of the mold portion 3 may be a synthetic resin having a main component of, for example, aromatic polyamide resin or polybutylene terephthalate resin. The material for the mold portion 3 may be of only a single type of material or a combination of two or more types of materials.

A method for manufacturing the terminal-attached electric wire 1 will now be described.

As shown in FIG. 2, in order to manufacture the terminal-attached electric wire 1, the exposed portion 6 is first formed by removing the insulator 5 from the end of the insulated electric wire 1a to expose the core wire 4. Next, the core wire connecting portion 2b of the terminal metal fitting 2 is connected to the core wire 4 at the exposed portion 6 by welding or crimping. This integrally couples and electrically connects the core wire 4 of the insulated electric wire 1a and the terminal metal fitting 2.

Then, the end of the insulated electric wire 1a is inserted through the adhesive tube 7. In this step, the inner diameter of the adhesive tube 7 is greater than the outer diameter of the insulated electric wire 1a (insulator 5).

Subsequently, in the step illustrated in FIG. 3, the adhesive tube 7 is heated by a heater or the like in a state in which the adhesive tube 7 is positioned to surround the end portion of the insulator 5. The heating shrinks the adhesive tube 7, which is a heat shrinkable tube, so that the adhesive tube 7 comes into touch contact with the outer circumferential surface of the insulator 5. Further, the inner circumferential surface of the adhesive tube 7, which is formed from a thermoplastic resin, is adhered to the outer circumferential surface of the insulator 5 by welding. That is, the inner circumferential surface of the adhesive tube 7 is adhered to the outer circumferential surface of the insulator 5 by the heat used to shrink the adhesive tube 7. In this case, the adhesive tube 7 and the insulator 5 are formed from the same type of synthetic resin (here, polyolefin-based resin) so that the adhesive tube 7 and the insulator 5 are readily bonded at the molecular level and firmly joined with each other.

The step of adhering the adhesive tube 7 to the end portion of the insulated electric wire 1a may be performed before or after connecting the terminal metal fitting 2 to the end of the insulated electric wire 1a.

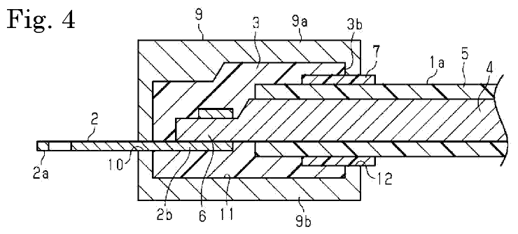

In the step illustrated in FIG. 4, the mold portion 3 is formed by performing insert molding using the portion from the core wire connecting portion 2b of the terminal metal fitting 2 to the axially intermediate portion of the adhesive tube 7 as an insert. In the present embodiment, the mold portion 3, which covers the protection region, is formed by performing insert molding using the protection region from the portion between the contact point portion 2a and the core wire connecting portion 2b of the terminal metal fitting 2 to the longitudinally intermediate portion of the adhesive tube 7 as an insert.

More specifically, a mold 9 is first prepared including three accommodation cavities 10, 11, and 12 in a state in which an upper mold 9a and a lower mold 9b are arranged closest to each other. Then, the protection region from the portion between the contact point portion 2a and the core wire connecting portion 2b of the terminal metal fitting 2 to the longitudinally intermediate portion of the adhesive tube 7 is accommodated in the accommodation cavity 11 of the mold 9. In this case, a portion of the terminal metal fitting 2 extending from the protection region toward the contact point portion 2a is partially accommodated in the accommodation cavity 10, and portions of the insulated electric wire 1a and the adhesive tube 7 extending from the protection region toward a side opposite to the contact point portion 2a are partially accommodated in the accommodation cavity 12. Subsequently, molten synthetic resin is injected into the accommodation cavity 11 of the mold 9 and hardened. This forms the mold portion 3, which covers the protection region, in the accommodation cavity 11. In this step, the heat generated during insert molding heats the adhesive tube 7. This welds and adheres the outer circumferential surface of the adhesive tube 7 to the inner circumferential surface of the mold portion 3. That is, the outer circumferential surface of the adhesive tube 7 is adhered to the inner circumferential surface of the mold portion 3 by the heat used to form the mold portion 3.

Moreover, in this step, the mold portion 3 is insert molded in a state in which the adhesive tube 7 is located between the insulator 5 of the insulated electric wire 1a and the inner edge in the rear end 3b of the mold portion 3, which is molded at the boundary of the accommodation cavity 11 and the accommodation cavity 12 of the mold 9. Thus, the adhesive tube 7 prevents molten synthetic resin from encroaching into the insulator 5 at the boundary between the accommodation cavity 11 and the accommodation cavity 12 during insert molding. This prevents the inner edge of the rear end 3b of the mold portion 3 from encroaching into the insulator 5.

The terminal-attached electric wire 1 has the following advantages.

(1) The inner circumferential surface of the adhesive tube 7 is adhered to the outer circumferential surface of the insulator 5, and the outer circumferential surface of the adhesive tube 7 is adhered to the inner circumferential surface of the mold portion 3. This closes the gap between the insulator 5 and the adhesive tube 7 and the gap between the adhesive tube 7 and the mold portion 3. As a result, the waterproofness of the mold portion 3 is improved, and the portion connecting the core wire 4 of the insulated electric wire 1a and the terminal metal fitting 2 is impervious to liquid.

(2) The adhesive tube 7 is located between the insulator 5 of the insulated electric wire 1a and the inner edge in the rear end 3b of the mold portion 3. This limits damages to the insulator 5 caused by the inner edge in the rear end 3b of the mold portion 3.

(3) A single adhesive tube 7 functions to adhere to the mold portion 3 to improve waterproofness and functions to protect the insulator 5. This allows a longitudinal dimension W (refer to FIG. 1) of the mold portion 3 to be smaller than a case where an adhesive layer, which improves the waterproofness of the mold portion 3, and a protection tube, which prevents damages to the insulator 5, are formed separately, and the adhesive layer and the protection tube are arranged next to one another in the longitudinal direction of the insulated electric wire 1a. In addition, the number of components can be reduced. This simplifies the manufacturing process.

(4) The adhesive tube 7 is a tubular member that is formed to be tubular before being arranged on the end portion of the insulator 5. Therefore, the adhesive tube 7 is not a member formed by applying or dropping a liquid adhesive on the outer circumferential surface of the insulator 5. Rather, the adhesive tube 7 is a member formed as a tubular body before the insulator 5 is arranged therein. This omits a step of applying or dropping a liquid adhesive on the outer circumferential surface of the insulator 5 and thus simplifies the manufacturing process.

(5) Further, the inner circumferential surface of the single-layered adhesive tube 7 is adhered to the outer circumferential surface of the insulator 5 by welding, and the outer circumferential surface of the adhesive tube 7 is adhered to the inner circumferential surface of the mold portion 3 by welding. This improves the waterproofness of the mold portion 3 without using a liquid adhesive.

When a liquid adhesive is used to obtain waterproofness of the mold portion 3, the liquid adhesive will have a tendency to have an uneven thickness. Further, adjustment of the viscosity of the liquid adhesive is difficult. Moreover, when a liquid adhesive is used, the adhesive needs to be dried in a drying step. The drying step takes time. In this respect, in the present embodiment, the waterproofness of the mold portion 3 is improved without using a liquid adhesive. This solves the above problems.

(6) In addition, the adhesive tube 7 is formed by a heat shrinkable tube or the like so that the wall thickness of the adhesive tube 7 can be readily increased as compared to when using a liquid adhesive. For example, when a liquid adhesive is used, it is difficult to set the wall thickness to 50 μm or greater during the manufacturing process. However, the wall thickness of the adhesive tube 7 in the present embodiment can be set to approximately 100 to 1000 μm. Thus, the wall thickness of the adhesive tube 7 can be set to approximately two to twenty times greater than that of when a liquid adhesive is used. Here, as the wall thickness of the adhesive tube 7 increases, the adhesive tube 7 can further readily fill the gap resulting from a difference in thermal expansion and thermal shrinkage between the insulator 5 and the mold portion 3. This allows the adhesive strength required for the adhesive tube 7 to be reduced. Thus, the degree of freedom is increased for selection of the material of the adhesive tube 7.

(7) The heat used to cause thermal shrinkage of the adhesive tube 7, which is formed by a heat shrinkable tube, adheres the inner circumferential surface of the adhesive tube 7 to the outer circumferential surface of the insulator 5. This simplifies the manufacturing process compared to when a step of the thermally shrinking the adhesive tube 7 and a step of adhering the inner circumferential surface of the adhesive tube 7 to the outer circumferential surface of the insulator 5 are performed separately.

(8) The heat generated when molding the mold portion 3 adheres the outer circumferential surface of the adhesive tube 7 to the inner circumferential surface of the mold portion 3. This simplifies the manufacturing process compared to when a step of forming the mold portion 3 and a step of adhering the outer circumferential surface of the adhesive tube 7 to the inner circumferential surface of the mold portion 3 are performed separately.

The above-described embodiment may be modified as follows.

In the above embodiment, the adhesive tube 7 is single-layered but should not be limited in such a manner. For example, an adhesive tube employed may be a triple-layered adhesive tube including a heat shrinkable tube, a thermoplastic first adhesive layer formed on an inner circumferential surface of the heat shrinkable tube, and a thermoplastic second adhesive layer formed on an outer circumferential surface of the heat shrinkable tube. In this case, the first adhesive layer is adhered to the insulator 5, for example, in a state in which a miscible layer (also referred to as compatible layer) is formed between and the first adhesive layer and the insulator 5 with the two layers mixed in the miscible layer. Further, the second adhesive layer and the mold portion 3 are adhered to each other in a state in which a miscible layer is formed in between.

In the above modified example, the material of the heat shrinkable tube is not limited to a thermoplastic resin.

It should be apparent to those skilled in the art that the present invention may be embodied in many other specific forms without departing from the technical concepts of the invention. For example, components described in the embodiment (or one or more of its modifications) may be partially omitted or combined. The scope of the invention is intended to embrace all such alternatives, modifications, and variations, along with all equivalents thereof, within the scope of the claims.

### DESCRIPTION OF THE REFERENCE NUMERALS

1) terminal-attached electric wire, 1a) insulated electric wire, 2) terminal metal fitting, 3) mold portion, 4) core wire, 5) insulator, 6) exposed portion, 7) adhesive tube

1. A terminal-attached electric wire, comprising:
an insulated electric wire including a core wire and an insulator that covers a periphery of the core wire;
a terminal metal fitting electrically connected to the core wire at an end of the insulated electric wire;
an adhesive tube that covers an end portion of the insulator; and
a mold portion formed to cover a region from a portion of the terminal metal fitting connected to the core wire to an axially intermediate portion of the adhesive tube, wherein
the adhesive tube is formed to be a tubular member before being arranged on the end portion of the insulator,
the adhesive tube includes an outer circumferential surface that is adhered to an inner circumferential surface of the mold portion, and
the adhesive tube includes an inner circumferential surface that is adhered to an outer circumferential surface of the insulator.

2. The terminal-attached electric wire according to claim 1, wherein the adhesive tube is single-layered.

3. The terminal-attached electric wire according to claim 2, wherein
the outer circumferential surface of the adhesive tube is adhered to the inner circumferential surface of the mold portion by welding, and
the inner circumferential surface of the adhesive tube is adhered to the outer circumferential surface of the insulator by welding.

4. The terminal-attached electric wire according to claim 2, wherein the adhesive tube has a wall thickness set to be in a range of 100 μm to 1000 μm.

5. The terminal-attached electric wire according to claim 2, wherein the adhesive tube is formed from a thermoplastic resin having a cross-linked structure.

6. The terminal-attached electric wire according to claim 2, wherein the adhesive tube is a member obtained by shrinking a heat shrinkable tube through which the end portion of the insulator is inserted.

7. A method for manufacturing a terminal-attached electric wire, the method comprising:
electrically connecting a terminal metal fitting to a core wire at an end of an insulated electric wire including the core wire and an insulator that covers a periphery of the core wire;
inserting an end portion of the insulator through a tubular adhesive tube formed from a thermoplastic resin;
adhering the adhesive tube to an outer circumferential surface of the end portion of the insulator; and
forming a mold portion by performing insert molding using a region from a portion of the terminal metal fitting connected to the core wire to an axially intermediate portion of the adhesive tube as an insert so that the mold portion covers the region,
wherein the forming a mold portion includes adhering an outer circumferential surface of the adhesive tube to an inner circumferential surface of the mold portion by welding.
